(19) United States
(12) Patent Application Publication
(10) Pub. No.: US 2009/0154172 A1
(43) Pub. Date: Jun. 18, 2009

(54) LED ASSEMBLY WITH HEAT DISSIPATION STRUCTURE

(75) Inventors: SHI-SONG ZHENG, Shenzhen (CN); LI HE, Shenzhen (CN)

Correspondence Address: PCE INDUSTRY, INC.;ATT. Steven Reiss, 458 E. LAMBERT ROAD, FULLERTON, CA, 92835, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 11/957,348

(22) Filed: Dec. 14, 2007

(51) Int. Cl. F21V 29/00

(52) U.S. Cl. 362/373

(57) ABSTRACT

An LED assembly includes a heat sink and a plurality of LED modules attached to the heat sink. The heat sink includes a heat conducting body and a plurality of fins extending from the heat conducting body. The heat conducting body has a middle flat portion and two sloped portions at two sides of the middle fat portion. Each sloped portion has a plurality of steps descending from the middle portion. The LED modules are thermally attached to the heat conducting body. Some of the LED modules are mounted on the middle flat portion and others are mounted on the steps of the sloped portions of the heat conducting body of the heat sink. The fins have distal ends cooperatively define a flat plane for the heat sink.

### BACKGROUND OF THE INVENTION

1. Field of the Invention

The present invention relates to an LED assembly, and particularly to an LED assembly having a heat dissipation structure for dissipating heat generated by LEDs thereof.

2. Description of related art

An LED assembly includes a plurality of light-emitting diodes (LEDs) as a source of illumination. An LED is a device for transferring electricity to light by using a theory that, if a current is made to flow in a forward direction in a junction region comprising two different semiconductors, electrons and cavities are coupled at the junction region to generate a light beam. The LED has an advantage that it is resistant to shock, and has an almost eternal lifetime under a specific condition; thus, when the LED assembly is used in a lamp, it is intended to be a cost-effective yet high quality replacement for incandescent and fluorescent lamps.

An LED assembly used in a lamp generally requires a plurality of LEDs, and most of the LEDs are driven at the same time, which results in a quick rise in temperature of the lamp. Generally, the lamp with the LED assembly does not have a heat dissipation device with good heat dissipating efficiency; operation of the LED assembly in the lamp thus has a problem of instability because of the rapid accumulation of heat. Consequently, the light from the LED assembly often flickers, which degrades the quality of the illumination. Furthermore, the LED assembly is used in a high temperature state for a long time and the life time thereof is consequently shortened. Furthermore, since the LEDs are mounted on a flat surface, the illumination angle of the LEDs is limited.

What is needed, therefore, is an LED assembly which has a heat dissipation structure with an improved heat dissipation capability. Furthermore, the LEDs mounted on the heat dissipation structure can have a large illumination angle.

### SUMMARY OF THE INVENTION

An LED assembly in accordance with a preferred embodiment of the present invention comprises a heat sink and a plurality of LED modules attached to the heat sink. The heat sink comprises a heat conducting body and a plurality of fins extending from the heat conducting body. The heat conducting body has a central flat portion and two sloped portions at two sides of the central flat portion. The LED modules are attached to the central flat portion and the two sloped portions of the heat conducting body and thermally connect therewith. The LED modules on the sloped portions are located at levels lowered gradually along an outward direction relative to the LED modules on the central portion, whereby an illumination angel of a lamp incorporating the LED assembly can be enlarged. Furthermore, the heat sink can effectively dissipate heat generated by the LED modules.

### BRIEF DESCRIPTION OF THE DRAWINGS

Many aspects of the present LED lamp can be better understood with reference to the following drawings. The components in the drawings are not necessarily drawn to scale, the emphasis instead being placed upon clearly illustrating the principles of the present LED lamp. Moreover, in the drawings, like reference numerals designate corresponding parts throughout the several views.

FIG. 1 is an isometric, exploded view of an LED assembly in accordance with a preferred embodiment of the present invention;

FIG. 2 is an assembled view of FIG. 1;

FIG. 3 is a top view of FIG. 2;

FIG. 4 is a lateral side view of FIG. 2; and

FIG. 5 is a front side view of FIG. 2.

### DETAILED DESCRIPTION OF THE INVENTION

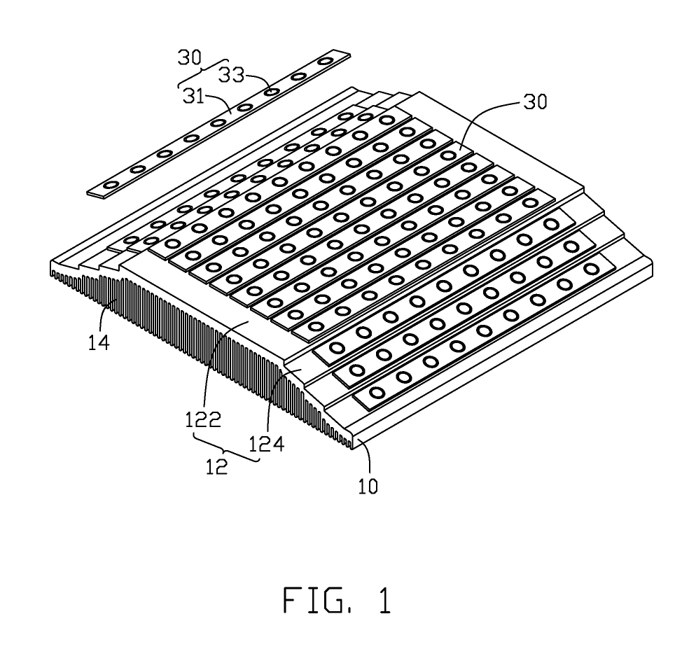

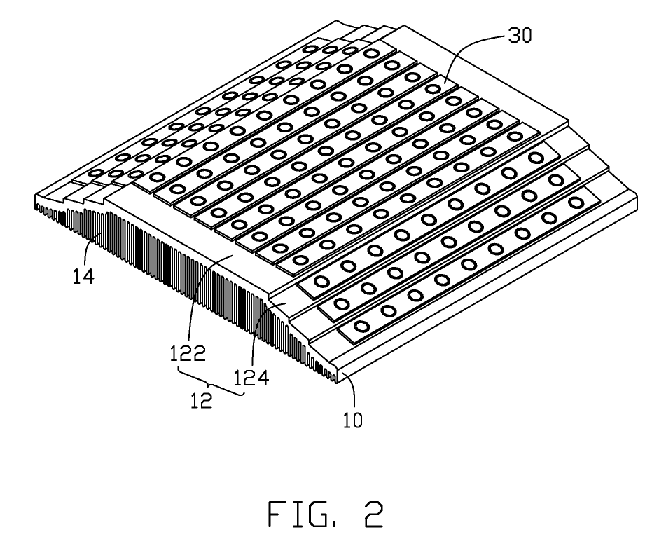

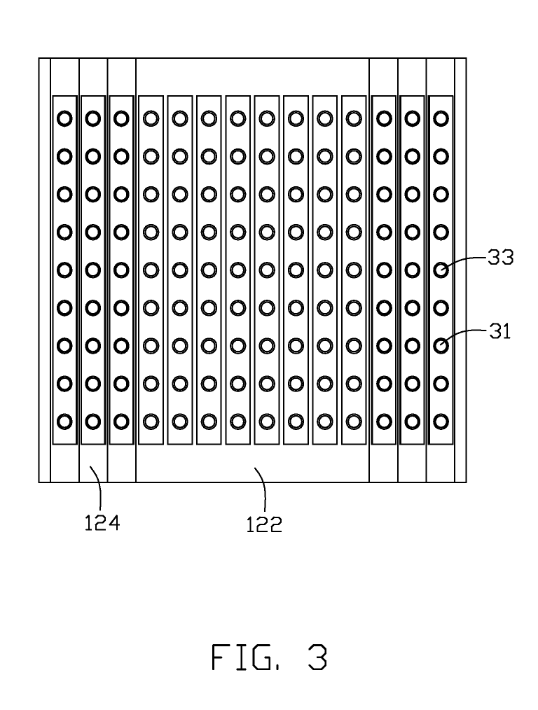

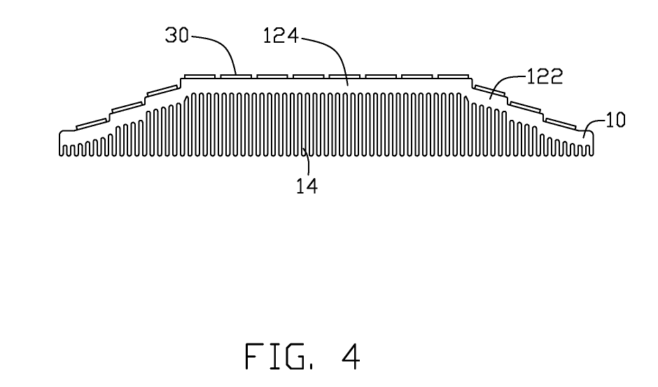

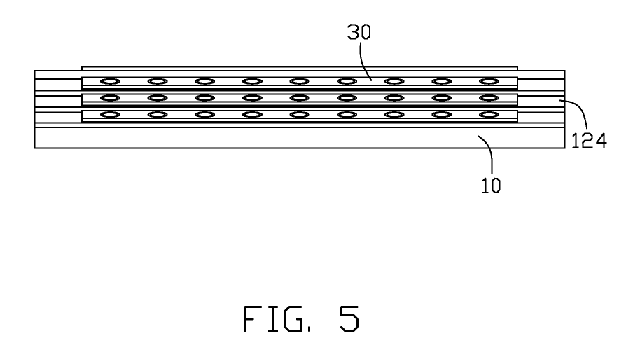

Referring to FIGS. 1-5, an LED assembly for a lighting purpose comprises a heat sink 10 and a plurality of LED modules 30 securely attached to a top face of the heat sink 10. The LED modules 30 are thermally connected with the heat sink 10.

The heat sink 10 has a trapeziform cross section in this embodiment and is integrally formed from one metal block. The heat sink 10 comprises a heat conducting body 12 and fins 14 extending from the conducting body 12. The heat conducting body 12 is substantially v-shaped and comprises a flat portion 122 and two wing portions 124 extending from two opposite sides of the flat portion 122. Each wing portion 124 is angled to the flat portion 122, wherein an angle between the wing portion 124 and the flat portion 122 can be varied according to the required illumination angle of the lamp in which the LED assembly is mounted. Each wing portion 124 forms a plurality of lengthwise steps (not labeled) parallel to flat portion 122 and descending from the flat portion 122. The steps (not labeled) have a same width. Each step has a flat face for attachment of a corresponding LED module 30 thereto. The fins 14 extend from the flat portion 122 and the wing portions 124 and are parallel to each other. The fins 14 are perpendicular to the flat portion 122. A plurality of air passages is defined between the fins 14. The heights of the fins 14 decrease from the flat portion 122 to the wing portions 124. The fins 14 have distal ends thereof flushing with each other. The distal ends of the fins 14 cooperatively define a bottom face (not labeled) for the heat sink 10.

The LED modules 30 are thermally attached to top faces of the flat portion 122 and the wing portions 124 of the heat sink 10. Each LED module 30 comprises an elongated printed circuit board 31 and a plurality of LEDs 33 equidistantly mounted on the printed circuit board 31. The LED modules 30 are on the heat sink 10 side-by-side and define a passage between every two adjacent ones thereof, for facilitating heat to be dissipated to ambient air. Each step of the wing portions 124 has one of the LED modules attached thereto. The printed circuit board 31 has a length shorter than that of the heat sink 10, whereby two lateral end portions of the flat portion 122 and the wing portions 124 extend beyond the LED modules 30.

When the LED modules 30 work, they generate heat. The heat is absorbed by the heat conducting body 12 and is transferred to the fins 14, and then is dissipated to ambient air by the fins 14.

According to the preferred embodiment of the present invention, the heat conducting body 12 is substantially V-shaped; the wing portions 124 are sloped outwardly relative to the flat portion 122, such that the LED modules 30 on the wing portions 124 are located at levels gradually lowered along an outward direction relative to the LED modules 30 on the flat portion 122. Furthermore, the LEDs 33 of the LED modules 30 on the wing portions 124 are directed at an angle relative to the LEDs 33 of the LED modules 30 on the flat portion 122. In other words, the LED modules 30 on the wing portions 124 are inclined relative to the LED modules 30 on the flat portion 122. Thus, an illuminating angle of the lamp in which the LED assembly is used can be broadened.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An LED assembly comprising:
a heat sink comprising a heat conducting body and a plurality of fins extending from the heat conducting body, the heat conducting body having two sloped portions at two sides thereof, and a plurality of LED modules thermally attached to the heat conducting body, wherein the LED modules on the sloped portions are oriented at an angle to other of the LED modules on the heat conducting body.

2. The LED assembly of claim 1, wherein the fins of the heat sink are parallel to each other.

3. The LED assembly of claim 1, wherein each of the sloped portions of the heat sink forms a plurality of steps each having one of the LED modules attached thereto.

4. The LED assembly of claim 3, wherein the conducting body of the heat sink comprises a flat portion, the two sloped portion extending from two opposite sides of the flat portion.

5. The LED assembly of claim 4, wherein the fins of the heat sink have heights thereof decreasing from the flat portion to the sloped portions.

6. The LED assembly of claim 5, wherein the fins are perpendicular to the flat portion of the heat sink.

7. The LED assembly of claim 1, wherein the LED modules defines a plurality of passages therebetween.

8. The LED assembly of claim 7, wherein each of the LED modules comprises a printed circuit board and a plurality of LEDs equidistantly mounted on the printed circuit board.

9. The LED assembly of claim 1, wherein the heat conducting body of the heat sink has two end portions extending beyond the LED modules.

10. An LED assembly, comprising:
a heat sink comprising a heat conducting body and a plurality of fins extending from the heat conducting body, and a plurality of LED modules thermally attached to the heat conducting body, wherein some of the LED modules are inclined relative to other of the LED modules, thereby broadening an illuminating angle of a lamp in which the LED assembly is used.

11. The LED assembly of claim 10, wherein the heat conducting body of the heat sink comprises a flat portion and two wing portions extending from two sides of the flat portion, each of the two wing portions being angled to the flat portion.

12. The LED assembly of claim 11, wherein the two wing portions of the heat conducting body of the heat sink forms a plurality of steps each having one of the LED modules attached thereto.

13. The LED assembly of claim 11, wherein the fins are parallel to each other.

14. The LED assembly of claim 11, wherein the fins are perpendicular to the flat portion of the heat conducting portion of the heat sink.

15. The LED assembly of claim 11, wherein the heat sink has a trapezium-shaped cross section.

16. An LED assembly comprising:
a heat sink having a middle flat portion, a pair of sloped portions extending from two opposite sides of the middle flat portion along opposite directions, and a plurality of fins extending from the flat portion and the sloped portions, wherein each sloped portion forming a plurality of steps descending from the middle flat portion; and
a plurality of LED modules each having a printed circuit board and a plurality of LEDs mounted on the printed circuit board, wherein some of the LED modules are mounted on the middle flat portion and some of the LED modules are mounted on the steps of the each sloped portion.

17. The LED assembly of claim 16, wherein the LED modules mounted on the steps of the each sloped portion are directed inclinedly relative to the LED modules on the middle flat portion.
